(19) United States
(12) Patent Application Publication
(10) Pub. No.: US 2009/0109129 A1
(43) Pub. Date: Apr. 30, 2009

(54) System and Method for Managing Information Handling System Display Illumination

(76) Inventors: Seen Yee Cheong, Singapore (SG); Chung Tze Fung, Singapore (SG); Tan Ben Jin, Singapore (SG); Lee Kwang Wee, Singapore (SG); Ong Aik Keong, Singapore (SG)

Correspondence Address: HAMILTON & TERRILE, LLP, P.O. BOX 203518, AUSTIN, TX, 78720, US

(21) Appl. No.: 11/927,909

(22) Filed: Oct. 30, 2007

(51) Int. Cl. G09G 1/14

(52) U.S. Cl. 345/20

(57) ABSTRACT

A webcam integrated in a portable information handling system captures ambient light for analysis and application in automatically adjusting settings of a display integrated in the information handling system. As an example, a histogram of the webcam is analyzed to determine ambient light intensity and color temperature, which is then applied to adjust the brightness, contrast and color settings of the display.

### BACKGROUND OF THE INVENTION

1. Field of the Invention

The present invention relates in general to the field of information handling system displays, and more particularly to a system and method for managing information handling system display illumination.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As information handling system technology has improved, end users have trended from reliance on desktop systems, which are generally immobile, towards greater reliance on portable systems. Portable information handling systems are built in a portable-sized housing that typically has an integrated power source, such as a rechargeable battery, and an integrated display, such as a liquid crystal display (LCD). The integrated power source and display allow the end user to use a portable information handling system free from external connections, such as external peripherals and power plugs. Wireless networking further improves the usability of portable information handling systems by allowing end users to remain in communication with other systems, such as by e-mail, instant messaging, chat or other types of applications. As an example, a portable information handling system user who has wireless networking and a “webcam” built into the housing can video conference with others from a variety of locations, such as an office, a home, an airport, a hotel, etc . . . A webcam is typically a digital camera integrated in the rotating lid of a portable information handling system near the display. The webcam takes a video of the area immediately in front of the display.

One difficulty that arises with portable information handling systems is that the image presented from an integrated display tends to vary depending upon the ambient lighting conditions. Ambient lighting conditions vary depending upon the environment in which the portable information handling system is located. For example, ambient light intensity at an outdoors location is often much greater than ambient light intensity in a home or office. In order to automatically adjust a display image for varying ambient light conditions, portable information handling systems sometimes include ambient light sensors. Ambient light sensors interface with a backlight of the integrated display so that the intensity of the backlight is automatically adjusted based upon the intensity of the ambient light detected by the ambient light sensor. Ambient light sensors are typically low cost lux meters that only sense and allow correction for the intensity of ambient light. Other display settings, such as color temperature and contrast, are not typically varied to adjust for varying ambient light conditions.

### SUMMARY OF THE INVENTION

Therefore a need has arisen for a system and method which more accurately corrects a display image for varying ambient light conditions.

In accordance with the present invention, a system and method are provided which substantially reduce the disadvantages and problems associated with previous methods and systems for correcting a display image for varying ambient light conditions. A camera associated with a display captures images, such as for video conferencing. An image captured by the camera is analyzed to determine ambient light characteristics, which are then applied to the display image to compensate for ambient light conditions at the display.

More specifically, a portable information handling system has a display and a webcam integrated in rotationally coupled lid. Processing components of the information handling system interfaced with the camera and display process visual information captured by the webcam and visual information presented by the display. Images captured by the webcam are periodically analyzed to determine ambient light characteristics at the display. For example, a histogram of a captured image is analyzed to determine ambient light intensity and color temperature. The ambient light intensity and color temperature are then applied to adjust illumination at the display, such as brightness, contrast and color settings of the display. Automated display setting adjustments are managed by an ambient light module running on the camera, the display, and or the information handling system.

The present invention provides a number of important technical advantages. One example of an important technical advantage is that a webcam integrated in an information handling system display provides a dual use as an ambient light sensor for the display, thus reducing system cost. Using the webcam as an ambient light sensor provides more accurate ambient light measurements when compared with the typical lux meter used as an ambient light sensor. The webcam also measures ambient light conditions other than just intensity, such as ambient light color temperature, so that the display image is adjusted for ambient color temperature, such as with automated adjustments to display color and contrast settings.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system that manages display illumination with ambient light compensation aided by a webcam; and

FIG. 2 depicts a block diagram of management of a display illumination with ambient light detected by a camera.

### DETAILED DESCRIPTION

Compensation of information handling system display settings with ambient light measured by a camera improves management of display illumination. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

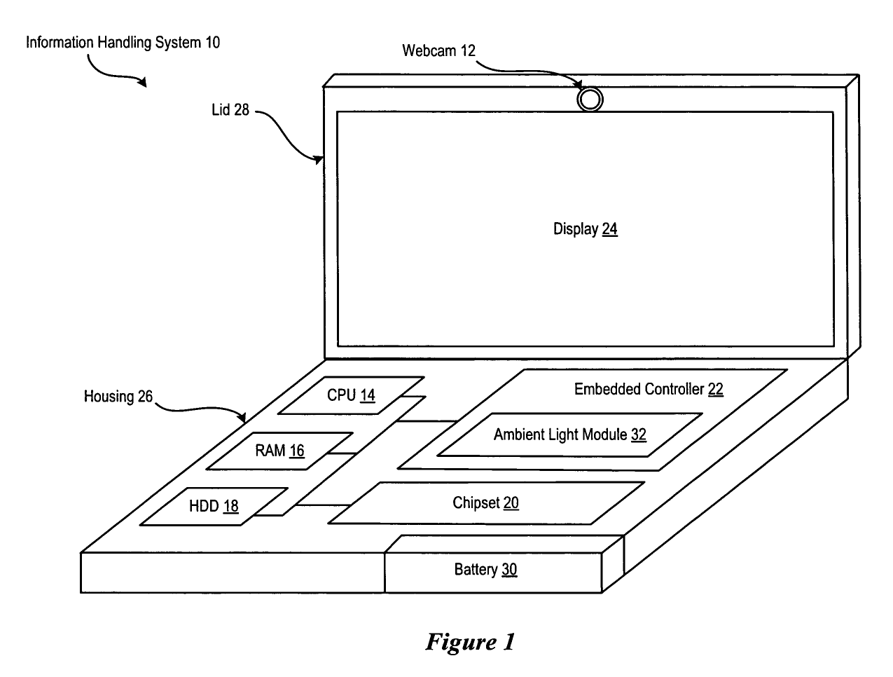

Referring now to FIG. 1, a block diagram depicts an information handling system 10 that manages display illumination with ambient light compensation aided by a webcam 12. Information handling system 10 processes information with a plurality of processing components, such as a CPU 14, RAM 16, a hard disk drive 18, a chipset 20 and an embedded controller 22. For example, an application running on CPU 14 generates visual information which is communicated to a display 24 through graphics components of chipset 20 for presentation as visual images. In the example embodiment depicted by FIG. 1, a portable information handling system 10 has a housing 26 with a rotationally-coupled lid 28 in an open position that exposes display 24. Portable information handling system 10 rotates lid 28 to a closed position for ease of transport and has a battery 30 that provides power to operate the processing components. Display 24 is a liquid crystal display that has pixels with liquid crystals illuminated by a backlight, such as a CCFL or LED backlight. The amount and color of light that passes through the pixels creates the visual image.

In operation, webcam 12 takes a video image of a user who is looking at display 24, such as in support of a video conference. Display 24 has a variety of settings that change the quality of a visual image presented at display 24. For instance, a brightness setting changes the intensity of the backlight that illuminates display 24. Contrast and color settings change the quality of light that passes through the liquid crystal pixels. Display settings are manually selectable through a user interface, such as an interface presented at display 24. For example, embedded controller 22 interfaces with display 24 to manage selection of brightness, contrast and color settings. The display is controlled according to the settings with the embedded controller, with a scalar or other logic on display 24 or with a combination of logic on information handling system 10 and display 24. Once a user establishes desired settings, an ambient light module 32 may be selected to adjust the settings to compensate for changes in ambient light conditions at display 24. Ambient light module 32 retrieves image information captured by webcam 24 and analyzes the image information to determine ambient light characteristics and applies the detected ambient light characteristics to adjust settings of display 24. The ambient light characteristics include the intensity of ambient light, such as changes of brightness associated with outdoor versus indoor environments, and the color temperature of ambient light, such as changes in “cool” versus “warm” lighting found in different environments, like a home, an office, an airport, etc . . . Ambient light module 32 adjusts brightness, contrast and color settings of display 24 to compensate for changes in the ambient light characteristics.

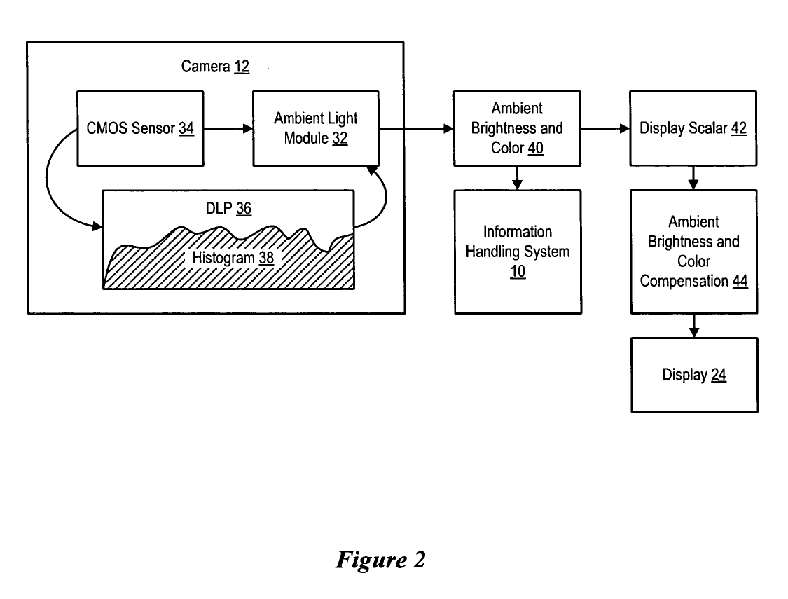

Referring now to FIG. 2, a block diagram depicts management of a display illumination with ambient light detected by a camera 12. Camera 12 includes a CMOS sensor 34 that detects light to digitally capture an image. For example, digital information captured by CMOS sensor 34 is processed by a DLP 36 or other specialized imaging hardware to generate a histogram 38. Ambient light module 32 processes histogram 38 by periodically capturing the image information from CMOS sensor 34 and DLP 36 to generate ambient light brightness and color values. As an example, histogram luminance levels are averaged or otherwise analyzed. Ambient light module 32 runs, for instance, as firmware instructions within camera 12, such as on a DLP, as firmware instructions associated with display 24, such as on a scalar 42, and/or as firmware instructions in an information handling system 10, such as in embedded controller 22. Hardware support for ambient light module 32 within camera 12 or display 24 allows compensation for ambient light conditions within a display independent of an information handling system, such as a display used to present images as a peripheral of a desktop information handling system. Ambient light brightness and color values 40 are processed to generate ambient brightness and color compensation 44. The compensation is applied to display 24 so that the image presented by display 24 has a consistent quality as ambient light conditions change.

Although the present invention has been described in detail, it should be understood that various changes, substitutions and alterations can be made hereto without departing from the spirit and scope of the invention as defined by the appended claims.

What is claimed is:

1. An information handling system comprising:
a housing;
processing components disposed in the housing and operable to process information;
a display integrated in the housing and interfaced with the processing components, the display operable to present the information as visual images according to plural settings;
a camera integrated in the housing and interfaced with the processing components, the camera operable to capture images; and
an ambient light module interfaced with the display and the camera, the ambient light module operable to analyze images captured by the camera to determine an ambient light characteristic and to apply the ambient light characteristic to adjust one or more display settings.

2. The information handling system of claim 1 wherein the ambient light characteristic comprises ambient light intensity and the adjusted display setting comprises display brightness.

3. The information handling system of claim 1 wherein the ambient light characteristic comprises ambient light color temperature and the adjusted display setting comprises display color.

4. The information handling system of claim 1 wherein the ambient light characteristic comprises ambient light color temperature and the adjusted display setting comprises display contrast.

5. The information handling system of claim 1 wherein the image captured by the camera comprises a histogram and wherein the ambient light module analyzes the histogram to determine the ambient light characteristic.

6. The information handling system of claim 1 wherein the housing comprises a rotationally coupled lid and wherein the display and camera are integrated in the lid.

7. The information handling system of claim 1 wherein the ambient light module comprises a DSP associated with the camera.

8. The information handling system of claim 1 further comprising a user interface operable to accept user preferences for use by the ambient light module.

9. The information handling system of claim 1 wherein the display comprises a liquid crystal display.

10. A method for managing information handling system display illumination, the method comprising:
capturing an image with a camera integrated in the display;
analyzing the captured image to determine an ambient light characteristic; and
applying the ambient light characteristic to automatically adjust one or more settings of the display.

11. The method of claim 10 wherein:
analyzing the captured image further comprises determining ambient light intensity; and
applying the ambient light characteristic further comprises automatically adjusting a brightness setting of the display.

12. The method of claim 10 wherein:
analyzing the captured image further comprises determining ambient light color temperature; and
applying the ambient light characteristic further comprises automatically adjusting a color setting of the display.

13. The method of claim 10 wherein:
analyzing the captured image further comprises determining ambient light color temperature; and
applying the ambient light characteristic further comprises automatically adjusting a contrast setting of the display.

14. The method of claim 10 further comprising:
communicating images captured by the camera to an information handling system; and
supporting a networked video conference at the information handling system with the images captured by the camera.

15. The method of claim 10 wherein the display comprises a liquid crystal display integrated in a lid rotationally coupled to an information handling system housing.

16. The method of claim 15 wherein the camera comprises a video camera integrated in the lid.

17. A system for managing information handling system display illumination, the system comprising:
a camera operable to capture images; and
an ambient light module interfaced with the camera, the ambient light module operable to analyze an image captured by the camera to determine an ambient light characteristic and to apply the ambient light characteristic to adjust one or more settings of a display.

18. The system of claim 17 wherein the ambient light characteristic comprises ambient light intensity and the setting comprises display brightness.

19. The system of claim 17 wherein the ambient light characteristic comprises color temperature and the setting comprises display color.

20. The system of claim 17 wherein the camera comprises a webcam operable to provide video to an information handling system to support a video conference communicated through a network.
